(19) United States
(12) Patent Application Publication
(10) Pub. No.: US 2024/0295522 A1
(43) Pub. Date: Sep. 5, 2024

(54) CLOSURE DEVICE FOR A MEASURING CHAMBER OF AN ELECTROCHEMICAL SENSOR

(71) Applicant: ProMinent GmbH, Heidelberg (DE)

(72) Inventors: Klaus KOPPERT, Mannheim (DE); Aldin RADETINAC, Pfungstadt (DE)

(73) Assignee: ProMinent GmbH, Heidelberg (DE)

(21) Appl. No.: 18/573,172

(22) PCT Filed: Jun. 22, 2022
(86) PCT No.: PCT/EP2022/067046

§ 371 Date: Dec. 21, 2023

(30) Foreign Application Priority Data
Jun. 22, 2021 (DE) 10 2021 116 153.3

(51) Int. Cl. G01N 27/333; G01N 27/404

(52) U.S. Cl. CPC G01N 27/333; G01N 27/404

(57) ABSTRACT

A closure device for a measuring chamber of an electrochemical sensor, a measuring chamber comprising such a closure device, and an electrochemical sensor comprising such a measuring chamber.

### FIELD

The invention relates to a closure device for a measuring chamber of an electrochemical sensor, a measuring chamber comprising such a closure device, and an electrochemical sensor comprising such a measuring chamber.

### BACKGROUND

In membrane-covered sensors for determining constituents in a sample, the electrode body is located in a reaction chamber, the measuring chamber, which is filled with an electrolyte and is in contact with the sample medium via a membrane. The pores of the membrane selectively allow the constituent of the sample to be determined to pass through into the measuring chamber. After diffusion through the membrane, the constituent is converted within the electrolyte space by reaction at the electrodes. This allows conclusions to be drawn about the content of the ingredient to be determined in the sample. By immersing the electrodes in the electrolyte, e.g. a KCl or KI solution, constant measuring conditions adapted to the respective process are ensured. In addition, the electrolyte often serves as a detection electrolyte, i.e. it contains a substance that is converted by the constituent of the sample to be determined to a detection constituent, which in turn is reduced at the working electrode in order to thereby indirectly detect the constituent to be determined.

Sensors of this type with membrane-covered measuring chambers are characterized by a reduced dependence on flow, water constituents and deposit-forming media. This means that optimum measuring conditions are maintained, irrespective of process conditions. Maintenance is usually carried out by replacing the membrane cap as soon as irregularities in the measuring accuracy are detected or the measuring signals fall below a threshold value.

However, even with such sensors, the result of the electrochemical measurement process is highly dependent on the active electrode surface and the concentration of the salt (e.g. KCl or KI) in the electrolyte in the measuring chamber. Over time, however, operation leads to deposits and changes on the electrode. These negative effects are particularly relevant if little or no analyte is present over a long period of time.

In addition, there is a depletion of the salt present in the electrolyte (“electrolyte loss”), especially if the medium to be measured has a low ion concentration.

In practice, this leads to a high maintenance effort and there is a risk of unreliable and incorrect measured values.

Particularly in the case of hydrophilic membranes, the loss of electrolyte, which reduces the concentration of the salt in solution (e.g. KCl or KI) in the electrolyte space over time, is particularly pronounced. This changes the equilibrium potential of the reference electrode, which in turn affects the measurement properties of the sensor.

In addition, the operating principle for indirect measurements with detection electrolyte (e.g. total chlorine sensors) is greatly weakened, which can lead to considerable loss of sensitivity, especially with regard to weak oxidants such as monochloramine.

Since the loss of electrolyte in such classical sensors, as shown for example in DE 10 2016 123 869 A1, is a factor that strongly affects the measurement capability, the closure device for a measurement chamber (“membrane caps”) has a significant influence on the measurement accuracy and lifetime of such sensors.

In addition, it should be noted that the regularly used commercial track-etched membranes can only be purchased with discrete pore sizes, which also results in discrete sensor slopes. Consequently, a fine adjustment of the sensor slope is not possible, or at least only insufficiently possible.

### SUMMARY

Against this background, the task of the present invention was therefore to provide a closure device for a measuring chamber of an electrochemical sensor, with which the above-mentioned problems can be overcome and which, in particular, makes it possible to increase the measuring accuracy of the sensor and to ensure longer-lasting measuring capability.

This task is solved according to the invention by a closure device for a measuring chamber of an electrochemical sensor for the determination of a constituent in a sample, wherein the closure device comprises a membrane with a permeable surface section, so that the membrane enables a selective supply or discharge of a substance to or from the measuring chamber in its operating position closing the measuring chamber, wherein the closure device comprises a masking element which at least partially closes the permeable surface portion of the membrane so that the supply or removal of the substance to or from the measuring chamber in its operating position closing the measuring chamber is at least partially blocked or at least inhibited.

The closure device is particularly suitable for electrochemical sensors for determining the concentration of a constituent of an aqueous sample medium, such as the measurement of bound and/or free chlorine.

The closure device according to the invention has a membrane with a permeable surface section, so that the membrane enables a substance-selective supply and/or removal of one or more substances, in particular of the constituent of the sample to be measured (“analyte”) and/or of the at least one salt contained in the electrolyte, to and/or from the measuring chamber (“semi-/selectively permeable”) when the closure device closes a measuring chamber of an electrochemical sensor. The membrane is preferably configured such that ions dissolved in the electrolyte and/or sample (e.g., analyte or salts dissolved in the electrolyte) can pass through it, but larger molecules and particles cannot. For this purpose, the membrane usually has pores of suitable sizes, via which selective size exclusion is achieved. Alternatively or additionally, selective inflow or outflow can also be achieved via charge effects or other mechanisms. Preferably, the membrane is permeable over its entire base area, i.e., the permeable surface portion of the membrane corresponds to the entire base area of the membrane.

The closure device further comprises a masking element characterized in that it at least partially closes the permeable surface portion of the membrane, such that the supply or removal of the substance to or from the measurement chamber is partially blocked or at least inhibited. Preferably, this is done by the masking element partially covering this surface section. The masking element is preferably an element present in the closure device in addition to the membrane. Alternatively, or in combination, the masking element may also fill part of the pores of the membrane so that they are no longer open. The Closure device may further comprise other elements, in particular housing and/or fastening means, for example to detachably attach the closure device to the other components of the measuring chamber, such as the housing. The closure device may preferably be a component that can be separated from the measuring chamber, for example a component that can be screwed onto the measuring chamber. An example of this is a screw-on membrane cap. According to the invention, however, the closure device can also be an integrally formed component of a measuring chamber.

In the context of the present invention, the term “electrolyte” includes ion-conducting media, in particular ion-conducting liquids, which contain at least one salt. Examples include aqueous salt solutions or gels containing salts. Particularly preferred are aqueous electrolytes, i.e. electrolytes with a water content of at least 70% by weight.

The “sample” whose constituent is to be determined is a liquid, preferably an ion-conducting one, such as water.

The “electrochemical sensor” comprises a measuring chamber which contains electrolyte and in which the working electrode and a reference electrode electrically connected to the working electrode are arranged, and optionally further electrodes such as counter electrodes which may be arranged inside or outside the measuring chamber. The measuring chamber is closed off by means of the closure device and the electrolyte contained in the measuring chamber comes into contact with the sample medium only via the membrane. In the context of the invention, a “working electrode” is that electrode which is used to determine the measured value of the electrochemical sensor. At this electrode, the constituent of the sample to be determined is electrochemically reduced and an analysis value is obtained from these processes. Preferably, the electrochemical sensor for which the closure device according to the invention is suitable is an amperometric sensor. In this, a voltage is applied between the working electrode and the reference electrode electrically connected to it during the measurement process and is controlled by a suitable arrangement such as a potentiostat. In such an amperometric sensor, the constituent is determined during a measurement by measuring the current flowing across the electrical connection between the working electrode and the reference electrode, and inferring the constituent from the measured current.

The “measuring device” is the spatially confined container comprising at least one electrochemical sensor. It may further comprise one or more spatially confined modules for flow control, pH measurement, control, and one or more pumps. The electrochemical sensor may be connected to the other modules, if any, via one or more connections that may include electrolyte. The sample ingredients and/or conditioning agent may be transported to the measurement chamber via pumps, and simultaneously or alternatively, the ingredients and/or conditioning agent may reach the measurement chamber by diffusion. They then diffuse through a preferably contained membrane and are reacted within the measurement chamber at the working electrode.

“Closing” is understood to mean any partial, almost complete, blocking or at least inhibition of the supply or discharge of the substance selectively supplied or discharged via the membrane. Preferably, this is accomplished by covering the permeable surface section of the membrane with the preferably completely impermeable masking element. Alternatively, blocking or inhibition can also be achieved by closing the pores, for example with a polymer material. Impurities or deposits deposited on or within the membrane in the course of use of the closure device for a measuring chamber of an electrochemical sensor are not masking elements in the sense of the present invention.

The design of the closure device according to the invention with a partial closing of the area over which the electrolyte can diffuse into the surrounding sample medium substantially reduces the loss of electrolyte and thereby significantly increases the service life of the electrochemical sensors. This effect is due in particular to the considerable lengthening and narrowing of the diffusion path of the ions dissolved in the electrolyte.

In addition, the inventors were able to determine a significant increase in the measuring accuracy of the electrochemical sensors provided with the closure devices according to the invention. The inventors assume that this is due, in addition to the reduced electrolyte loss, also to a directed diffusion of the constituent of the sample to be determined towards the working electrode of the measuring chamber.

Furthermore, by defining the permeable area of the membrane with the help of the masking element, the slopes of the sensors can be specifically adjusted and changed. In particular, if the masking element is an additional element not located within the membrane, this can be done by simply adjusting the closure device, namely by replacing the masking element.

Furthermore, the ratio of measurement sensitivities, especially in the case of internal masks, can be adjusted and adapted to the specific measurement conditions by selecting the thickness, shape and permeable area of a mask, the electrolyte placed between the working electrode and the membrane.

In the detection of oxidants of various strengths (e.g. chlorine, monochloramine), indirect sensors with detection electrolyte that have an upstream chemical reaction cause an local increase in the concentration of the detection electrolyte, which is important for detection, in the volume section between the working electrode and membrane when a masking element is used. This is particularly advantageous for chlorine sensors, in particular total chlorine sensors. Without this concentration adjustment, oxidants that differ substantially in strength would be measured with different slopes, which would make the underlying sensor suitable for measuring the total chlorine content (sum of free chlorine and monochloramine) only to a very limited extent.

Preferably, the masking element closes ≥50%, more preferably ≥60%, even more preferably ≥70%, even substantially more preferably ≥80%, even substantially more preferably ≥80%, and most preferably ≥90% or even ≥95%, of the permeable surface section.

The masking element is preferably an element, such as a film, which is present in the closure device in addition to the membrane and is preferably detachably attached, in particular laid on, to the membrane. Such an arrangement can be realized in a particularly simple and cost-efficient manner.

Preferably, the masking element covers the membrane, for example when the masking element is configured as a foil, wherein the masking element preferably covers ≥50%, more preferably ≥60%, even more preferably ≥70%, even considerably more preferably ≥80%, and most preferably ≥90% or even ≥95%, of the permeable surface section.

The material of which the masking element is composed of at least 50% by weight, more preferably at least 80 wt. %, is preferably a synthetic material, in particular a polymer material, which is particularly preferably selected from a polymer from the group consisting of PET or PBT, polyamide, polyimide, polyamideimide, polyaramide, poly(metha)acrylates, polytetrafluoroethylene (PTFE), polyethylene, polypropylene, polychloride, PVC, elastane, polycarbonate, polyvinyl alcohol, polyphenyl sulfide, melamine, polyurea, polyurethane, polybenzimidazole, polyvinylidene fluoride (PVDF). Particularly preferably, the material of the masking element is resistant to chemicals and/or can be processed by laser. This enables a permanently stable mask with high flexibility.

In a preferred embodiment of the invention, the masking element is a film, in particular a film of polymeric material, wherein the thickness of the film is preferably ≤100 μm, more preferably ≤75 μm, even more preferably ≤50 μm and most preferably ≤30 μm. Preferably, however, the thickness of the film is ≥5 μm, more preferably ≥10 μm and most preferably ≥15 μm.

Preferably, the thickness of the film is in a range of 5 μm to 100 μm, more preferably 10 μm to 75 μm, even more preferably 15 μm to 50 μm and most preferably 15 μm to 30 μm. In the ranges described above, the effects according to the invention are particularly pronounced, especially since the film then has a sufficient thickness and at the same time is still easy to handle and install.

Preferably, the masking element, in particular if this is in the form of a film, has openings made by punching or laser cutting. The foil covers the surface of the membrane at least on one side except for the “opened” areas.

The geometry and number of openings can be freely selected and adapted to the respective reaction conditions.

In another preferred embodiment of the invention, the masking element is designed as a coating which is applied to a part of the membrane so that the supply or discharge of the substance to or from the measuring chamber is at least partially blocked or at least inhibited.

In a preferred embodiment of the invention, the masking element is connected to the membrane in a force-fit, form-fit or material-fit manner, preferably in a force-fit or material-fit manner.

The masking element can be attached to the membrane, for example, by adhesive bonding, hot pressing or cold pressing. This is particularly advantageous for highly porous membranes, because this closes the pores except for the open areas, which further enhances the advantageous effects according to the invention.

In one embodiment of the invention, the masking element is not bonded to the membrane or is bonded only in such a way that it can be separated from the membrane again in a non-destructive manner (at least as far as the membrane is concerned). This allows easy replacement of the masking element and thus a particularly high flexibility of the closure device. Particularly compared with non-destructively separable material bonds, such as coatings, such arrangements have the advantage of better mechanical load-bearing capacity under changing pressures. In addition, there is no or only a reduced risk of embrittlement or chemical degradation. In addition, such arrangements are particularly easy to manufacture and can be used universally, especially with smooth surfaces such as core track membranes made of PET. Due to the flexible choice of materials, masking elements of high chemical stability, in particular high oxidation resistance, can also be used.

In a preferred embodiment of the invention, the membrane consists of ≥50 wt.-%, more preferably ≥60 wt.-%, even considerably more preferably ≥80 wt.-%, and most preferably ≥90 wt.-% of a polymer material, wherein the polymer material is particularly preferably selected from the group consisting of polyethylene terephthalate (PET) or polycarbonate (PC), silicone, polytetrafluoroethylene (PTFE), polyvinylidene fluoride (PVDF), poly-ethersulfone (PES) particularly preferably polyethylene terephthalate (PET) or polycarbonate (PC).

In a preferred embodiment of the invention, the membrane is sponge-like or core track etched, i.e., it has perforations introduced by ion track technology. These membranes can be particularly easily closed in sections by a masking element, e.g. a filler of polymer material, introduced into the pores.

In a preferred embodiment of the invention, the closure device is configured and adapted in such a way that, in its operating position closing the measuring chamber, the masking element is arranged between the membrane and the measuring chamber. That is, in other words, the masking element limits the permeable surface section of the membrane on the side facing the measuring chamber. This is particularly preferred in accordance with the invention, since it not only reduces electrolyte loss, but also ensures particularly pronounced directed diffusion of the sample constituent to be determined to the working electrode of the measuring chamber. Between the working electrode and the membrane, a relative increase in concentration is produced compared to an arrangement with a closure device without a mask. Since electrolyte loss is inhibited, the concentration at the working electrode can be kept high for a longer period of time, which increases the service life of a measuring chamber closed with the closure device according to the invention.

In another preferred embodiment of the invention, the closure device is configured and adapted in such a way that, in its operating position closing the measuring chamber, the membrane is arranged between the masking element and the measuring chamber. That is, in other words, the masking element limits the permeable surface portion of the membrane on the side facing away from the measuring chamber.

The invention also relates to a measuring chamber for an electrochemical sensor comprising a closure device as defined in the claims and aforementioned. Such a measuring chamber preferably comprises at least one electrolyte with salt contained therein, a working electrode and a reference electrode, and optionally further electrodes such as one or more counter electrodes, between which an electrical signal can be determined in a measuring interval, from which the ingredient can be inferred.

The invention also relates to an electrochemical sensor comprising the measuring chamber described above.

The invention also relates to an electrochemical sensor for a measuring device for determining a constituent of a sample, comprising a membrane-covered measuring chamber which is filled with an electrolyte comprising a salt, in which a working electrode and a reference electrode are arranged, between which an electrical signal can be determined in a measuring interval, from which the constituent can be deduced. Due to the partial closing of the membrane with a masking element, the measuring chamber, in particular in the volume section arranged between the membrane and the working electrode, has a higher concentration of the salt in the electrolyte compared to an arrangement without a masking element.

This advantageous effect is particularly pronounced when the electrolyte is a detection electrolyte. A detection electrolyte has a salt that is converted to a detection constituent by the constituent of the sample to be determined, for example by oxidation. The detection constituent is reduced at the working electrode, and the constituent to be determined is inferred based on the change in the measured quantity. For example, if an iodide salt solution is used as the detection electrolyte of a measuring device for determining Cl₂ in a sample, the constituent of the sample to be determined, Cl₂, oxidizes the I⁻ contained in the detection electrolyte to the detection constituent I₂.

$${Cl}_{2} + 2 {e}^{-} \to 2 {Cl}^{-} Reduction$$

$$2 {I}^{-} \to {I}_{2} + 2 {e}^{-} Oxidation$$

$${Cl}_{2} + 2 {I}^{-} \to 2 {Cl}^{-} + {I}_{2} Total$$

The detection component I₂ can then be reduced at the working electrode and the constituent Cl₂ of the sample can be inferred from the measured value obtained.

By forming an “electrolyte chamber” with salt enriched in it, a higher measurement sensitivity is achieved. If this electrolyte space in front of the working electrode is missing, the salt present in the measuring chamber (in the above case iodide) is not sufficient to achieve a complete conversion of the constituent to be determined. The advantageous effect according to the invention is particularly pronounced in the determination of bound chlorine, since monochloramine is clearly more unreactive than free chlorine.

In a preferred embodiment, the sample ingredient to be determined is an oxidizing agent, such as oxidatively acting halogen compounds like those of chlorine, bromine and iodine, chloramines and bromamines, Cl₂, Br₂, O₃, ClO₂, peracetic acid, H₂O₂, a chlorite or hypochlorite salt or the corresponding acid, preferably hypochlorous acid (HOCl).

In a preferred embodiment, the electrolyte is an iodide salt solution and the detection component is I₂.

The invention also relates to a measuring device for determining a constituent of a sample comprising an electrochemical sensor as defined in the claims and aforementioned.

The invention also relates to the use of a masking element in a closure device of a membrane-covered electrochemical sensor for partially blocking or at least inhibiting the supply or removal of a substance to or from the measuring chamber.

The invention also relates to the use of the closure device according to the invention in a measuring chamber of an electrochemical sensor for increasing the service life of the electrochemical sensor and/or increasing the measuring accuracy of the sensor.

### BRIEF DESCRIPTION OF THE FIGURES

The appended figures represent specific embodiments of the invention, thereby show

FIG. 1: Schematic side view of a special embodiment of an inventive measuring chamber with selectively permeable membrane.

FIG. 2: Schematic top view of a special embodiment of an inventive measuring chamber with selectively permeable membrane.

### DETAILED DESCRIPTION

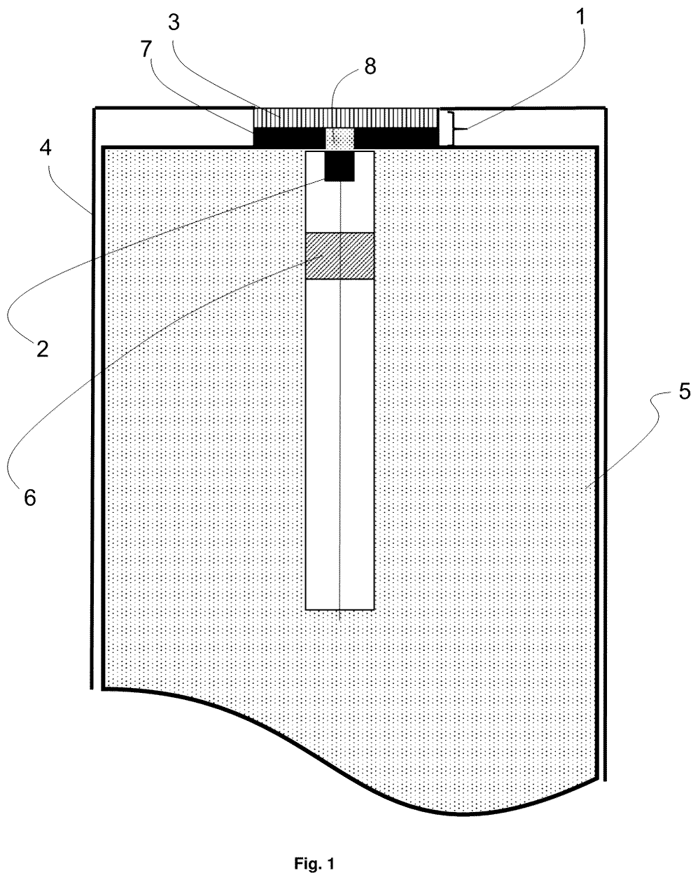

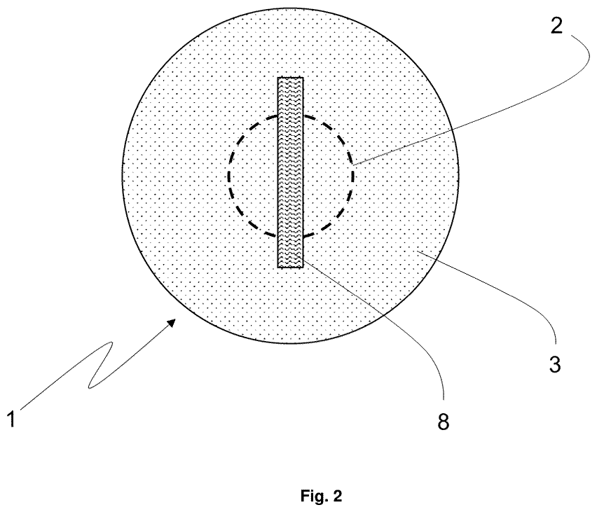

FIGS. 1 and 2 show a schematic representation of a measuring chamber 4 of an electrochemical sensor according to the invention, which is covered by a closure device 1 according to the invention. The closure device comprises a selectively permeable membrane 3 and a masking element 7 arranged thereon in the direction of the measuring chamber. The electrode body of the measuring chamber has a working electrode 2 and an associated reference electrode 6. The face side of the working electrode 2 is surrounded by electrolyte 5, which is in contact with the sample via the membrane. The working and reference electrodes are connected to each other via a measuring device (not shown), so that during a measuring interval an electrical signal can be determined from which the presence of a constituent in a sample can be inferred. The electrode body is connected to the electronics (not shown) and immerses with the two electrodes in the electrolyte of the measuring chamber 4. Salt of a certain concentration is dissolved in the electrolyte 5. The housing of the measuring chamber is screwed to the closure device. This forms an electrolyte space 8 arranged between the working electrode and the membrane, which has a higher concentration of salt (than in an arrangement without masking element 7) and in the present case has a rectangular, linear shape.

The substance selectively permeable section of the membrane 3, which covers the measuring chamber 4, has a section which is not covered by the masking element 7. This is preferably equal to or smaller than the face side of the working electrode 2 and is arranged so that at least 80% of its projection onto the base area of the working electrode 2 is on the base area of the working electrode.

### REFERENCE SIGNS

1 Closure device
2 Working electrode
3 Membrane
4 Measuring chamber
5 Electrolyte in measuring chamber
6 Reference electrode
7 Masking element
8 Electrolyte space in closure device

1-14. (canceled)

15. A closure device for a measuring chamber of an electrochemical sensor for determining a constituent in a sample, the closure device having a membrane with a permeable surface section so that the membrane allows a substance to be supplied to and/or discharged from the measuring chamber, wherein the closure device comprises a masking element which at least partially closes the permeable surface section of the membrane so that the supply and/or discharge of the substance to and/or from the measuring chamber is partially blocked or at least inhibited.

16. The closure device according to claim 15, wherein the masking element closes ≥70%, preferably ≥90%, of the permeable surface section.

17. The closure device according to claim 15, wherein the masking element is a foil with openings preferably created by punching or laser cutting.

18. The closure device according to claim 15, wherein the masking element is connected to the membrane in a force-fit, form-fit or material-fit manner, preferably in a force-fit manner.

19. The closure device according to claim 15, wherein the membrane comprises or consists of a polymer material.

20. The closure device according to claim 19, wherein the polymer material is polyethylene terephthalate (PET) or polycarbonate (PC).

21. The closure device according to claim 15, wherein the membrane is track-etched or sponge-like.

22. The closure device according to claim 15, wherein the closure device is configured and adapted such that in its operating position closing the measuring chamber, the masking element is arranged between the membrane and the measuring chamber.

23. The closure device according to claim 15, wherein the closure device is configured and adapted such that, in its operating position closing the measuring chamber, the membrane is arranged between the masking element and the measuring chamber.

24. A measuring chamber for an electrochemical sensor comprising a closure device according to claim 15.

25. An electrochemical sensor comprising a measuring chamber according to claim 24, wherein the electrochemical sensor is preferably a chlorine sensor.

26. he electrochemical sensor according to claim 25, wherein said electrochemical sensor is a chlorine sensor, preferably a total chlorine sensor.

27. A measuring device for determining a constituent of a sample comprising an electrochemical sensor according to claim 25.
